(19) United States
(12) Patent Application Publication
(10) Pub. No.: US 2008/0307012 A1
(43) Pub. Date: Dec. 11, 2008

(54) TSB-TREE PAGE SPLIT STRATEGY

(75) Inventor: David B. Lomet, Redmond, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/758,029

(22) Filed: Jun. 5, 2007

(51) Int. Cl. G06F 17/30

(52) U.S. Cl. 707/203; 707/E17.044

(57) ABSTRACT

A system and method that is designed to effectuate and facilitate time and key splitting of versioned database pages in a temporal database. The system includes a component that examines the page when it is full. The component can thereafter selectively undertake a time split or key split of the versioned database page, wherein the key split can be delayed until a single version current utilization of the versioned database page and a single version utilization of a oldest version on the versioned database page exceeds a threshold utilization at which point an exclusive key split can be performed.

### BACKGROUND

Conventional database systems typically capture only a single logical state of modeled reality—only the most contemporaneous version or state is persisted/maintained. Typically, as database transactions occur over time conventional database systems evolve from one state to the next such that previous states are discarded once database transactions commit. Consequently, conventional database systems, generally do not persist prior states of data, but rather capture only the current view of reality and as such are typically inadequate to support applications that warrant maintenance of past, current, and future data (e.g., temporal database applications that require maintenance and access to data that utilizes a time horizon (time dimension) in addition to a key dimension). Multi-versioned data, when updated, can result in new versions of data being created. Because these versions are retained, several versions of a record can exist, each appropriate to a particular instant in time.

There are many applications where multiple versions of data can be of interest. These can include financial transactions, transcript archives in universities, multiple version histories in engineering design, legal records, medical records, and the like. Nevertheless, irrespective of the purpose for maintaining multiple temporal instances of data, the goal of any database system and temporal database systems in particular, is to ensure fast access to current records while perhaps tolerating slower access to historical records. Thus, in order to satisfy this aim and because temporal databases generally comprise two dimensions—a key dimension and a time dimension—temporal database pages can be split in either the time dimension or the key dimension in order to facilitate indexing data in the temporal database.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

The claimed subject matter relates to database engines that can be included in temporal database systems and that enable high performance for temporal applications. More particularly, the claimed subject matter relates to systems and methods that effectuate and facilitate indexing by means of page splitting in temporal/versioned databases. Accordingly, in one illustrative aspect the claimed subject matter includes a component that can selectively impose a time split or key split on versioned database pages so as to ensure a minimum version occupancy for each page. The claimed subject matter improves upon prior art by permitting the key split to be delayed until the single version current utilization of the versioned database page and the single version utilization of a oldest version on the versioned database page both exceed a threshold utilization.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 provides a block diagram of a temporal database system that facilitates and effectuates page splitting of database pages that contain versioned records in accordance with one aspect of the claimed subject matter.

FIG. 2 provides an illustrative state diagram that can be employed by an aspect of the claimed subject matter.

FIG. 3 provides a flow diagram of a method that facilitates and effectuates page splitting in accordance with the claimed subject matter

FIG. 4 provides a further flow diagram for methodology that facilitates and effectuates page splitting in accordance with an aspect of the claimed subject matter.

FIG. 5 illustrates a block diagram of a computer operable to execute the disclosed transaction time indexing with version compression architecture.

FIG. 6 illustrates a schematic block diagram of an exemplary computing environment for processing the transaction time indexing with version compression architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

Versioned or temporal databases typically comprise two dimensions, the key (or record id) dimension and the time dimension. Because there are two dimensions versioned or temporal database pages resident in a versioned or temporal database can be split in either the key dimension or the time dimension in order to facilitate indexing the data in the database.

A characteristic of temporal or versioned data is that the versions, because they can be updated at different times, can have disparate lifetimes. Thus, for instance, when a page is split in the time dimension it is generally unlikely that a time can be found that clearly separates versions between an old time and a new time. Accordingly, if each page is to reference some rectangular region in a key/time space, versions need to be duplicated across a time spit boundary. These duplicates therefore create additional versions (e.g., multiple versions of a record) which tend to reduce overall effective storage utilization of the aggregate of all versions.

A further characteristic of temporal or versioned data, and in particular the indexing thereof, is that when a key split is undertaken, an indication of version density (e.g., density of versions on the page at a particular time) should be provided, and preferably a guarantee supplied, such that when the key split is undertaken there is a guarantee that there are least a threshold number of versions (or storage occupied by the versions) extant on the page prior to the performance of the key split. By eliciting such a guarantee (e.g., that the number of versions (or their storage) existing on the page equals or exceeds a threshold condition prior to executing a key split) the minimum storage utilization for those versions is generally half the maximum required. Thus, utilizing normal assumptions typically employed by those conversant with the subject matter, in particular storage utilization, average utilization will tend to be the maximum storage utilization (U-max) multiplied by a natural logarithm of 2 (ln(2)) (e.g., U-max*ln(2)).

An important aspect of performance of range queries in index trees, such as B-Trees, is the storage utilization of each page that is accessed. For example, for conventional B-Trees, storage utilization (U) has an average of typically 0.69 or the natural logarithm of 2 (e.g., ln(2)). This results from the node splitting strategy utilized by B-Trees. This strategy is to first let each page fill with records. When the next record is added (or an update increases the size of an existing record), the page (e.g., B-Tree node) is split into two pages, each with approximately 0.5 storage utilization. Over time, these pages subsequently fill and the splitting process continues as above (e.g., pages split and records distributed between the two pages such that storage utilization approximates 0.5). The typical averaged 0.69 storage utilization is the result of the foregoing splitting strategy, averaged over all pages of the B-tree. This average typically is the maximum storage utilization (U-max) multiplied by the natural logarithm of 2 (e.g., U-max*ln(2)). For instance, when employing B-Trees, U-max can be set to 1.00, in which case maximum utilization of any page is generally considered to be 100%. Conversely, U-min, the minimum storage utilization of any page, is 0.5 (e.g., half of U-max).

For the Time Split B-Tree, the situation can be slightly more complex. Records can be replicated a number of times to ensure the record is represented in each Time Split B-Tree node whose key time boundaries intersect the lifetime of the record or version. Thus, when a range search is implemented (e.g., a range search looking for versions extant as-of a particular instant in time) it is the version storage utilization for any as-of query requesting a range of versions of records that were current as-of the time being requested that is pertinent. The number of pages that need to be accessed to locate all the keys and all the records in a particular time slice that satisfy a specific key range (or are within the key boundaries specified) is inversely related to the version utilization and it is this number of pages that largely determine the cost of the search. This version storage utilization can be termed the single version utilization (SVU). Accordingly, the higher the storage utilization of a particular version of a record the fewer the pages that need to be accessed, and thus the lower the cost will be for doing the range search.

Thus, it is a good idea to try to maintain reasonably high single version utilization for versioned data in pages. Nevertheless, there is a basic dilemma in that the higher the key splitting threshold, the more time splitting needs to be done; the more time spitting that is done, the more redundancy is introduced, and hence there must be a delicate balance between driving up single version utilization and trying to maintain the multi-version total utilization—utilization of all the data (without considering duplicates) divided by storage required. It should be noted, that multi-version total utilization goes down as the key splitting threshold goes up because more duplicate versions of records are introduced to ensure that each page contains versions in each time range.

It is possible to put bounds on single version utilization in the same way that a B-Tree bounds storage utilization (U). This result can be achieved by using a Write Once B-Tree (WOB) strategy (e.g., forced on it by its write-once medium). The strategy can be summarized as follows. When a page fills, check the storage utilization (SVU) of the current version. This is the up-to-date or latest version, and can be referred to as the single version current utilization or SVU(current). This utilization, unlike in the B-tree, will not typically be 1.0 as the current version usually shares the page with other prior versions. Rather the single version current utilization (SVU(current)) can be compared to some threshold utilization denoted as U-thresh. Where the single version current utilization, SVU(current), is less than or equals the threshold utilization, U-thresh, then do not key split the page; rather, undertake a time split. A time split divides the page into a new current page (e.g., whose time range begins at the current time, and extends indefinitely into the future) and a history page which is the original page (e.g., whose time range begin time was established when the page was initially created from a prior split, and whose end time is the current time). The history page contains exactly the data of the original full page (e.g., it is this page, unchanged). The new current page thus contains only the record versions that are current. Where the single version current utilization, SVU(current) exceeds threshold utilization, U-thresh, then first perform a time split as above, and immediately perform a key split, dividing the current version between two new current pages. Thus, the single version current utilization (SVU(current))−max utilization (U-max) is guaranteed to be at least the threshold utilization (U-thresh); the single version current utilization (SVU(current))−minimum utilization (U-min) is guaranteed to be at least half the threshold utilization (U-thresh) (e.g., 0.5*U-thresh); and the single version utilization (SVU) for any version will average at least the threshold utilization multiplied by the natural logarithm of 2 (e.g., U-thresh*ln(2)).

The foregoing discussion would indicate that the threshold utilization (U-thresh) should be set to be close to 1.0 since this increases single version utilization (SVU). But there is a tradeoff to be made. The higher the threshold utilization (U-thresh) is set, the more time splitting occurs. Every time there is a time split, the current version is replicated in both the resulting current and history pages. To keep this redundancy under control, threshold utilization (U-thresh) can be a set to a value between 0.66 and 0.8, which similar to B-Tree storage utilization, produces a single version average utilization (SVU-avg) that equals single version maximum utilization (SVU-max) multiplied by the natural logarithm of 2 (ln(2)) and is greater than the threshold utilization (U-thresh) multiplied by a natural logarithm of 2 (ln(2)) (e.g., SVU-avg=SVU-max*ln(2)>U-thresh*ln(2)).

In order to improve upon the tradeoff between high single version utilization (SVU) and the amount of version replication that can be produced when a time split occurs, it would be advantageous to preserve the guarantees about single version minimum utilization (SVU-min) and single version maximum utilization (SVU-max) so that single version average utilization (SVU-avg) continues to be at least the single version maximum utilization multiplied by the natural logarithm of 2 (ln(2)) (e.g., SVU-max*ln(2)). The subject matter as claimed, while leaving the threshold utilization (U-thresh) unchanged, results in unchanged version redundancy but strictly higher values for single version utilization (SVU) (e.g., SVU-avg(new)>=SVU-avg(WOB)).

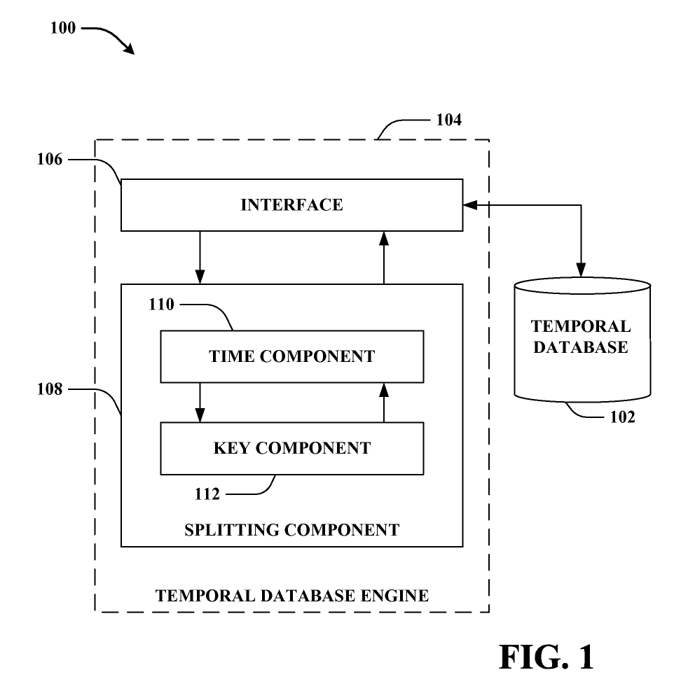

FIG. 1 depicts a system 100 that effectuates and facilitates page splitting in a temporal database 102 in accordance of an aspect of the claimed subject matter. System 100 can include temporal database engine 104 that comprises interface component 106 (hereinafter referred to as “interface 106”) that can receive data from a multitude of sources, such as, for example, data associated with a particular query, service, user, client, and/or entity involved with an online transaction and/or a portion of an online transaction, and thereafter can convey the received information to splitting component 108 for further analysis. Interface 106 can subsequently receive appropriate indication from splitting component 108 to cause a database page resident in temporal database 102 to split on time and/or on key.

Interface 104 can provide various adapters, connectors, channels, communication pathways, etc., to integrate the various components included in system 100 into virtually any operating system and/or database system and/or with one another. Additionally, interface 104 can provide various adapters, connectors, channels, communication modalities, etc., that can provide for interaction with various components that can comprise system 100, and/or any component (external and/or internal), data and the like associated with system 100.

Splitting component 108 can ascertain the point at which a page containing versioned records has been filled. When the page has been determined to be full, splitting component 108 can check storage utilization of the current version (SVU(current)) against threshold utilization (U-thresh). Where the single version current utilization is less than or equal threshold utilization (e.g., SVU(current)<=U-thresh) splitting component 108 can cause the page resident in temporal database 102 to be split on time.

Where the single version current utilization (SVU(current)) is assessed to be greater than threshold utilization (U-thresh) (e.g., SVU(current)>U-thresh), splitting component 108 can check the single version utilization of the oldest version as of the begin time of the page (SVU(old)) against the threshold utilization (U-thresh). Where splitting component 108 determines that the value of the single version utilization of the oldest version as of the begin time of the page (SVU(old)) is less than or equal to threshold utilization (U-thresh), splitting component 108 can effectuate a time split of the page rather than undertaking both a time split immediately followed by a key split of the page.

Where splitting component 108 infers that the single version current utilization (SVU(current)) exceeds threshold utilization (U-thresh) (e.g., SVU(current)>U-thresh) and the single version utilization of the oldest version as of the begin time of the page (SVU(old)) exceeds threshold utilization (U-thresh) (e.g., SVU(old)>U-thresh), then splitting component 108 can perform a key split (e.g., there is no time split) of the page. At this point splitting component 108 can divide the old version entries and their associated newer versions based on the midpoint of the old version.

The effect of the foregoing is as follows. The key and time split of the write-once B-tree strategy is maintained, however, the key split is deferred until the page fills again (e.g., a time split is done as normal, but the key split that would normally have been implemented immediately following the performance of the time split is deferred to a later time). The result is that after the deferred key split is done, the result is exactly the same as if the write-once B-tree (WOB) strategy had been utilized. But until the deferred key split is done higher storage utilization for all versions in the un-split page is maintained. Consequently, such a splitting strategy produces better version utilization (SVU) without changing the amount of version redundancy present.

As illustrated, splitting component 106 can further include a time component 110 and a key component 112. Time component 110 can perform time splits by dividing a versioned database page into a new current page (e.g., whose time range commences at the current time and extends indefinitely into the future) and a history page which can be the original page (e.g., whose time range begin time was established when the page was initially created from a prior split, and whose end time is the current time). Typically, a history page contains exactly the data from the original full-page. The current page, in contrast, generally contains record versions that are current. Accordingly, time component 110 can actualize time splits when threshold utilization equals or exceeds single current version utilization (e.g., U-thresh=>SVU(current)). Additionally and/or alternatively, time component 110 can further perform a time split (e.g., deferring the key split to a subsequent time) when splitting component 108 provides indication that single version current utilization exceeds threshold utilization (e.g., SVU(current)>U-thresh) and the single version utilization of the oldest version as of the begin time of the page is less than or equal threshold utilization (e.g., SVU(old)<=U-thresh).

Key component 112 can perform key splits by dividing and distributing old version entries and associated newer versions based on the midpoint of the old version. In other words, for example, when indication is obtained from splitting component 108 that single version current utilization exceeds threshold utilization (e.g., SVU(current)>U-thresh) and single version utilization of the oldest version as of the begin time of the page at issue (e.g., SVU(old)>U-thresh), key component 112 can divide and/or distribute old version entries and associated newer versions based at least in part on the midpoint of the old version.

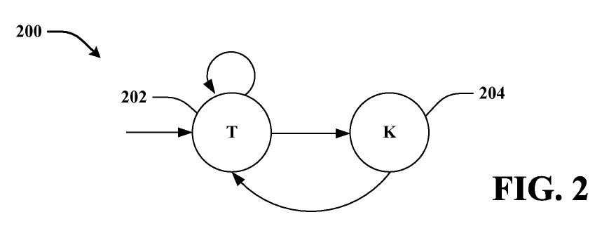

FIG. 2 depicts an illustrative state diagram 200 that can be employed by an aspect of the claimed subject matter to facilitate and effectuate page splitting. As illustrated, state diagram 200 can comprise two states, T (202) and K (204) that can represent the performance of a time split and a key split respectively. At state T (202) once it has been determined that a page containing versioned records has become full, a component (e.g., splitting component 108) can check storage utilization of the current version against threshold utilization (e.g., SVU(current) vs. U-thresh). Where single version current utilization is less than or equal threshold utilization (e.g., SVU(current)<=U-thresh) the component can perform a time split (e.g., divide the page into a new current page and a history page which can be the original page), and then wait (e.g., until single version current utilization (SVU(current)) exceeds threshold utilization (U-thresh) and single version utilization of the oldest version (SVU(old)) exceeds threshold utilization (U-thresh)) before proceeding to state K (204). Similarly, where single version current utilization (SVU(current)) exceeds threshold utilization (U-thresh) the component can check single version utilization of the oldest version (SVU(old)) against threshold utilization (U-thresh). Where single version utilization of the oldest version (SVU(old)) is less than or equal to threshold utilization (U-thresh) the component can perform a time split on the page and once again wait before proceeding to state K (204) (e.g., there is no transition to state K (204) until single version current utilization (SVU(current)) exceeds threshold utilization (U-thresh) and the single version utilization of the oldest version (SVU(old)) exceeds threshold utilization (U-thresh)). When the single version current utilization exceeds threshold utilization and the single version utilization of the oldest version exceeds threshold utilization (e.g., SVU(current)>U-thresh and SVU(old)>U-thresh) the component can transition to state K (204) whereupon the component can perform a key split by dividing the old version entries and their associated newer versions based on the midpoint of the old version. Once the key split has been performed the state transitions back to state T (202).

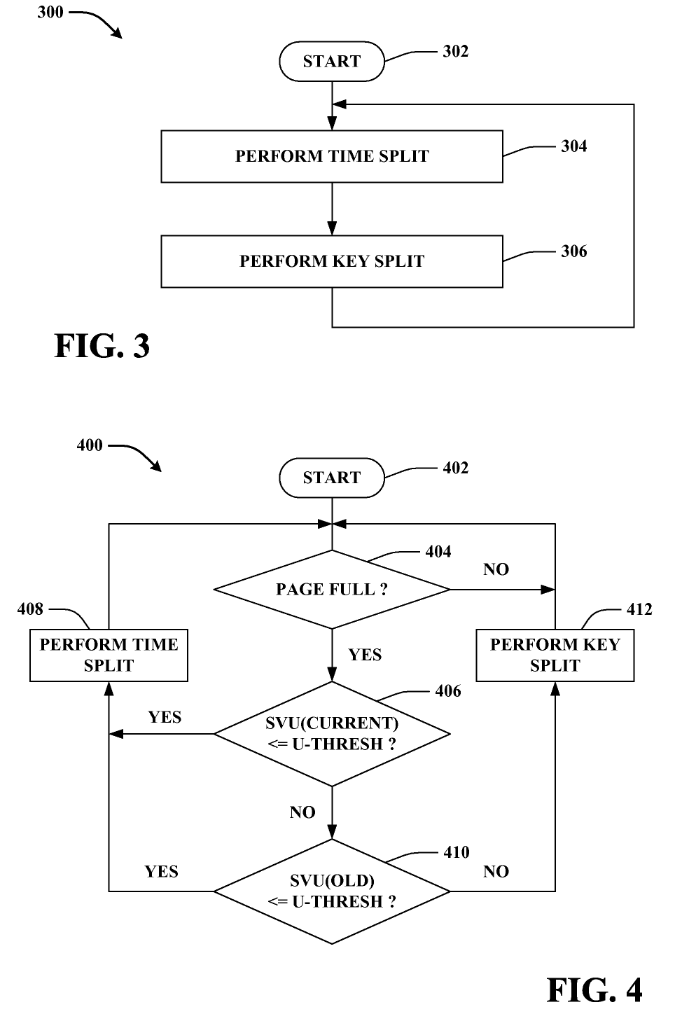

In view of the exemplary systems shown and described supra, methodologies that may be implemented in accordance with the disclosed subject matter will be better appreciated with reference to the flow charts of FIG. 3 and FIG. 4. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 3 provides a flow diagram of a method 300 that facilitates and effectuates page splitting in accordance with an aspect of the claimed subject matter. Beginning at 302, various process initialization tasks and background activities can be performed at which point method 400 proceeds to 304. At 304 once it has been determined that a page containing versioned records has become full a time split of that page can be effectuated. More particularly, a check is made regarding the storage utilization of the current version and threshold utilization. Where it is determined that single version current utilization is less than or equal threshold utilization a time split is performed, as indicated at 304. Further, where single version current utilization is ascertained to be greater than threshold utilization but single version utilization of the oldest version is determined to be less than or equal threshold utilization a time split can also be performed at 304. At 306 a key split can be performed where it is determined that both single version current utilization and single version utilization of the oldest version exceeds a threshold value. Once a key split has been performed at 306, method 300 can cycle back to 304.

FIG. 4 provides a flow diagram of methodology 400 that facilitates and effectuates page splitting in accordance with an aspect of the claimed subject matter. Methodology 400 commences at 402 where various initialization tasks can be undertaken at which point the method can proceed to 404. At 404 a determination is made as to whether or not a database page containing versioned records is full. Where it is found that the database page is not full (e.g., NO) the method cycles back, otherwise method 400 proceeds to 406. At 406 a further determination is made as to whether or not a current single version utilization (e.g., SVU(current)) is less than or equal a threshold utilization (e.g., U-thresh). Where the current single version utilization (SVU(current)) is found to be less than or equal the threshold utilization (U-thresh) the method can proceed to 408 at which point a time split can be performed on the database page after which the method cycles back to the beginning. On the other hand, where current single version utilization (SVU(current)) is found to be greater than the threshold utilization (U-thresh) the method proceeds to 410. At 410 method 400 ascertains whether or not a single version utilization of the oldest version as of the begin time of the page (e.g., SVU(old)) exceeds the threshold utilization (U-thresh). Where the single version utilization of the oldest version as of the begin time of the page (SVU(old)) is greater than the threshold utilization (U-thresh) the method can proceed to 412 where a key split can be performed after which the method returns to be the beginning of the methodology. Alternatively, where it is determined at 410 that single version utilization of the oldest version as of the begin time of the page (SVU(old)) is less than or equal the threshold utilization (U-thresh) the method can transition to 408 where the page at issue can be split based on time, after which the method cycles to the beginning.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

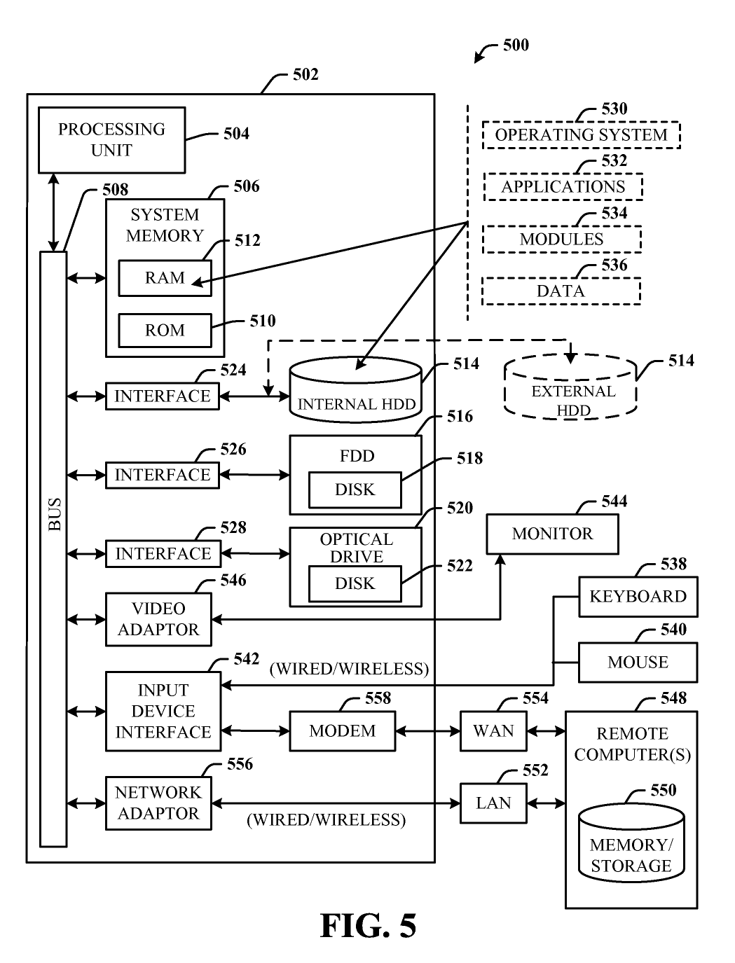

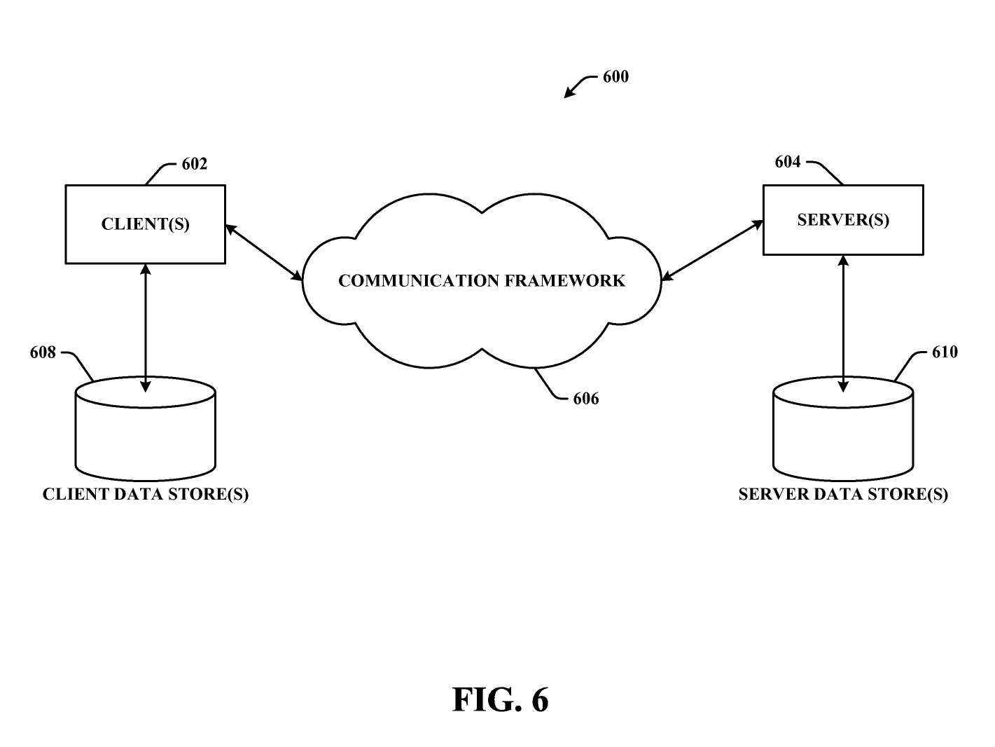

Referring now to FIG. 5, there is illustrated a block diagram of a computer operable to execute the disclosed system that splits versioned database pages. In order to provide additional context for various aspects thereof, FIG. 5 and the following discussion are intended to provide a brief, general description of a suitable computing environment 500 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 5, the exemplary environment 500 for implementing various aspects includes a computer 502, the computer 502 including a processing unit 504, a system memory 506 and a system bus 508. The system bus 508 couples system components including, but not limited to, the system memory 506 to the processing unit 504. The processing unit 504 can be any of various commercially available processors. Dual microprocessors and other multi-processor architectures may also be employed as the processing unit 504.

The system bus 508 can be any of several types of bus structure that may further interconnect to a memory bus (with or without a memory controller), a peripheral bus, and a local bus using any of a variety of commercially available bus architectures. The system memory 506 includes read-only memory (ROM) 510 and random access memory (RAM) 512. A basic input/output system (BIOS) is stored in a non-volatile memory 510 such as ROM, EPROM, EEPROM, which BIOS contains the basic routines that help to transfer information between elements within the computer 502, such as during start-up. The RAM 512 can also include a high-speed RAM such as static RAM for caching data.

The computer 502 further includes an internal hard disk drive (HDD) 514 (e.g., EIDE, SATA), which internal hard disk drive 514 may also be configured for external use in a suitable chassis (not shown), a magnetic floppy disk drive (FDD) 516, (e.g., to read from or write to a removable diskette 518) and an optical disk drive 520, (e.g., reading a CD-ROM disk 522 or, to read from or write to other high capacity optical media such as the DVD). The hard disk drive 514, magnetic disk drive 516 and optical disk drive 520 can be connected to the system bus 508 by a hard disk drive interface 524, a magnetic disk drive interface 526 and an optical drive interface 528, respectively. The interface 524 for external drive implementations includes at least one or both of Universal Serial Bus (USB) and IEEE 1394 interface technologies. Other external drive connection technologies are within contemplation of the claimed subject matter.

The drives and their associated computer-readable media provide nonvolatile storage of data, data structures, computer-executable instructions, and so forth. For the computer 502, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed and claimed subject matter.

A number of program modules can be stored in the drives and RAM 512, including an operating system 530, one or more application programs 532, other program modules 534 and program data 536. All or portions of the operating system, applications, modules, and/or data can also be cached in the RAM 512. It is to be appreciated that the claimed subject matter can be implemented with various commercially available operating systems or combinations of operating systems.

A user can enter commands and information into the computer 502 through one or more wired/wireless input devices, e.g., a keyboard 538 and a pointing device, such as a mouse 540. Other input devices (not shown) may include a microphone, an IR remote control, a joystick, a game pad, a stylus pen, touch screen, or the like. These and other input devices are often connected to the processing unit 504 through an input device interface 542 that is coupled to the system bus 508, but can be connected by other interfaces, such as a parallel port, an IEEE 1394 serial port, a game port, a USB port, an IR interface, etc.

A monitor 544 or other type of display device is also connected to the system bus 508 via an interface, such as a video adapter 546. In addition to the monitor 544, a computer typically includes other peripheral output devices (not shown), such as speakers, printers, etc.

The computer 502 may operate in a networked environment using logical connections via wired and/or wireless communications to one or more remote computers, such as a remote computer(s) 548. The remote computer(s) 548 can be a workstation, a server computer, a router, a personal computer, portable computer, microprocessor-based entertainment appliance, a peer device or other common network node, and typically includes many or all of the elements described relative to the computer 502, although, for purposes of brevity, only a memory/storage device 550 is illustrated. The logical connections depicted include wired/wireless connectivity to a local area network (LAN) 552 and/or larger networks, e.g., a wide area network (WAN) 554. Such LAN and WAN networking environments are commonplace in offices and companies, and facilitate enterprise-wide computer networks, such as intranets, all of which may connect to a global communications network, e.g., the Internet.

When used in a LAN networking environment, the computer 502 is connected to the local network 552 through a wired and/or wireless communication network interface or adapter 556. The adaptor 556 may facilitate wired or wireless communication to the LAN 552, which may also include a wireless access point disposed thereon for communicating with the wireless adaptor 556.

When used in a WAN networking environment, the computer 502 can include a modem 558, or is connected to a communications server on the WAN 554, or has other means for establishing communications over the WAN 554, such as by way of the Internet. The modem 558, which can be internal or external and a wired or wireless device, is connected to the system bus 508 via the serial port interface 542. In a networked environment, program modules depicted relative to the computer 502, or portions thereof, can be stored in the remote memory/storage device 550. It will be appreciated that the network connections shown are exemplary and other means of establishing a communications link between the computers can be used.

The computer 502 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 10 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10 BaseT wired Ethernet networks used in many offices.

Referring now to FIG. 13, there is illustrated a schematic block diagram of an exemplary computing environment 600 for processing the system that effectuates and facilitates splitting of versioned database pages in accordance with another aspect. The system 600 includes one or more client(s) 602. The client(s) 602 can be hardware and/or software (e.g., threads, processes, computing devices). The client(s) 602 can house cookie(s) and/or associated contextual information by employing the claimed subject matter, for example.

The system 600 also includes one or more server(s) 604. The server(s) 604 can also be hardware and/or software (e.g., threads, processes, computing devices). The servers 604 can house threads to perform transformations by employing the claimed subject matter, for example. One possible communication between a client 602 and a server 604 can be in the form of a data packet adapted to be transmitted between two or more computer processes. The data packet may include a cookie and/or associated contextual information, for example. The system 600 includes a communication framework 606 (e.g., a global communication network such as the Internet) that can be employed to facilitate communications between the client(s) 602 and the server(s) 604.

Communications can be facilitated via a wired (including optical fiber) and/or wireless technology. The client(s) 602 are operatively connected to one or more client data store(s) 608 that can be employed to store information local to the client(s) 602 (e.g., cookie(s) and/or associated contextual information). Similarly, the server(s) 604 are operatively connected to one or more server data store(s) 610 that can be employed to store information local to the servers 604.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system implemented on a machine that partitions database pages, comprising:
a component that examines a versioned database page received from an interface to selectively time split or key split the page, the key split delayed until a single version current utilization of the versioned database page and a single version utilization of a oldest version on the versioned database page exceeds a threshold utilization.

2. The system of claim 1, the component time splits the database page based at least in part on a comparison of the single version current utilization of the versioned database page with the threshold utilization.

3. The system of claim 1, the component time splits the database page based on the single version current utilization of the versioned database page being less than or equal the threshold utilization.

4. The system of claim 1, the component time splits the database page based at least in part on the single version current utilization of the versioned database page being greater than the threshold utilization and the single version utilization of a oldest version on the versioned database page being less than or equal the threshold utilization.

5. The system of claim 1, the component key splits the database page based at least in part on the single version current utilization of the versioned database page exceeding the threshold utilization.

6. The system of claim 1, the component key splits the database page based at least in part of the single version current utilization of the versioned database page and the single version utilization of the oldest version on the versioned database page exceeding the threshold value.

7. The system of claim 1, the key split divides old version entries and associated newer versions based at least in part on a midpoint in the old version entries.

8. The system of claim 1, the component splits the page based at least in part on a middle key of the oldest version on the page to guarantee the oldest version has at least a minimum acceptable utilization.

9. The system of claim 1, the time split divides the versioned database page into a current page and a history page.

10. The system of claim 9, the current page associated with a time range that begins at a current time.

11. The system of claim 9, the history page associated with a begin time established when the versioned database page was created from a prior split and an end time that is a current time.

12. A machine implemented method that effectuates partitioning of versioned database pages, comprising:
examining a versioned database page to determine whether to perform a time split or a key split; and
selectively postponing the key split of the page based at least on a single version current utilization of the page and a single version utilization of an oldest version on the page exceeding a threshold utilization.

13. The method of claim 12, further includes performing a time split of the page based on a comparison of the single version current utilization and the threshold utilization of the page.

14. The method of claim 12, further includes undertaking a time split when the single version current utilization exceeds the threshold utilization of the page and the single version utilization of the oldest version on the versioned database page is less than the threshold utilization of the page.

15. The method of claim 12, further includes dividing old version entries and associated newer versions of the page based at least in part on a midpoint in the older version entries where the single version current utilization of the page and the single version utilization of the oldest version on the page exceed the threshold utilization.

16. The method of claim 12, further includes dividing the page into a current page and a history page.

17. The method of claim 16, the current page associated with a current time.

18. The method of claim 16, the history page associated with an end time that is a current time and a begin time that indicates a time that prior split was performed.

19. The method of claim 12, further include performing the key split exclusively when the single version current utilization of the page and the single version utilization of the oldest version on the page exceeds the threshold utilization.

20. A system that effectuates partitioning of temporal database pages, comprising:
means for examining time split and key split information; and
means for exclusively performing a key split of a versioned database page based on a single version current utilization of the versioned database page and a single version utilization of an oldest version on the versioned database page exceeding a threshold utilization.
